(19) United States
(12) Patent Application Publication
(10) Pub. No.: US 2012/0318424 A1
(43) Pub. Date: Dec. 20, 2012

(54) TIRE HAVING A CROWN AREA PROVIDED WITH A SUBLAYER COMPRISING A THERMOPLASTIC ELASTOMER

(75) Inventors: Garance Lopitaux, Valignat (FR); Didier Vasseur, Clermont-Ferrand (FR); Béatrice Lopez, Chavaroux (FR)

(73) Assignees: Michelin Recherche Et Technique, Granges-Paccot (CH); Compagnie Generale Des Establissements Michelin, Clermont-Ferrand (FR)

(21) Appl. No.: 13/518,222

(22) PCT Filed: Dec. 15, 2010
(86) PCT No.: PCT/EP2010/069777

§ 371 Date: Aug. 10, 2012

(30) Foreign Application Priority Data
Dec. 23, 2009 (FR) 0959463

(51) Int. Cl. B60C 1/00; B60C 9/02; B60C 9/18

(52) U.S. Cl. 152/526

(57) ABSTRACT

Radial tire having:
a crown surmounted by a tread having at least one radially outer elastomer layer which contacts the road when the tire is rolling;
two inextensible beads, two sidewalls connecting the beads to the tread, a carcass reinforcement passing into the two sidewalls and anchored in the beads;
a crown reinforcement or belt placed circumferentially between the carcass reinforcement and the tread;
a radially inner elastomer sublayer, having a formulation different from the formulation of the radially outer elastomer layer, and placed between the radially outer layer and the belt,
   wherein said sublayer contains a rubber composition having at least one diene elastomer, a reinforcing filler and more than 10 phr of a hydrogenated thermoplastic styrene copolymer, which makes possible substantial improvement in rolling resistance and handling performance compromise.

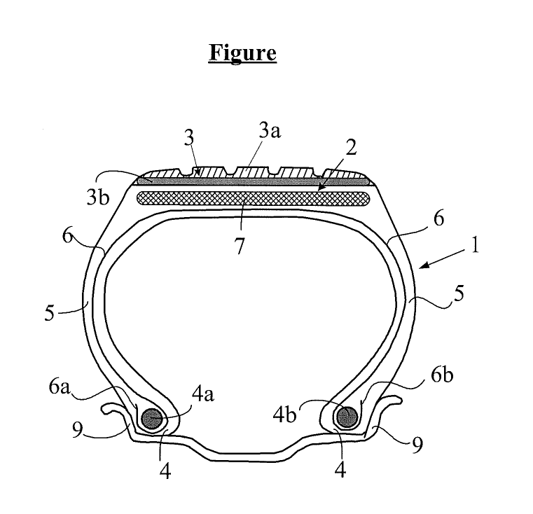

The present invention relates to the elastomer layers used in the crown of tyres and to the rubber compositions based on diene elastomers and on thermoplastic styrene (TPS) elastomers, used for the manufacture of such tyres.

As is known, a tyre has to meet a large number of often conflicting technical requirements, including a high wear resistance, a low rolling resistance, and good handling performance on a motor vehicle.

This compromise in properties, in particular from the viewpoint of the rolling resistance and handling performance, was able to be improved in recent years with regard to energy-saving “Green Tyres”, intended in particular for passenger vehicles, by virtue in particular of the use of novel low hysteresis rubber compositions having the feature of being reinforced predominantly by specific inorganic fillers, described as reinforcing fillers, in particular by highly dispersible silicas (HDSs), capable of rivalling, from the viewpoint of the reinforcing power, conventional tyre-grade carbon blacks.

To improve the handling performance, it is known that a higher stiffness of the crown is desirable, it being possible for this stiffening of the crown to be obtained for example by increasing the reinforcing filler content or by incorporating certain reinforcing resins into the rubber compositions forming this crown (see, for example, document WO 02/10269), or by placing an elastomer sublayer between the belt and the outer part of the tread of the tyre, having a stiffness greater than that of said outer part.

As is known, however, such a stiffening of the crown may adversely affect the hysteresis and therefore the rolling resistance of the tyres.

By continuing their research, the applicants have discovered a sublayer for a tyre that comprises a rubber composition comprising at least one diene elastomer and one specific thermoplastic copolymer, which composition makes it possible to improve the stiffness of the crown and therefore the handling performance of the tyres, while decreasing the hysteresis and therefore the rolling resistance of the tyres.

Thus, a first subject of the invention relates to a radial tyre for a motor vehicle comprising:
a crown surmounted by a tread provided with at least one radially outer elastomer layer intended to come into contact with the road when the tyre is rolling;
two inextensibles beads, two sidewalls connecting the beads to the tread, a carcass reinforcement passing into the two sidewalls and anchored in the beads;
the crown being reinforced by a crown reinforcement or belt placed circumferentially between the carcass reinforcement and the tread;
a radially inner elastomer layer known as a “sublayer”, having a formulation different from the formulation of the radially outer elastomer layer, this sublayer being placed between the radially outer layer and the belt,
   characterized in that said sublayer comprises a rubber composition comprising at least one diene elastomer, a reinforcing filler and more than 10 phr of a hydrogenated thermoplastic styrene copolymer (referred to as “TPS elastomer”).

The tyres of the invention are particularly intended to be fitted on motor vehicles of the passenger type, SUVs (“Sport Utility Vehicles”), two-wheel vehicles (especially motorcycles), aircraft, and also industrial vehicles selected from vans and heavy vehicles (i.e. underground trains, buses, heavy road transport vehicles such as lorries, tractor units, trailers and off-road vehicles such as agricultural or civil-engineering vehicles), and other transport or handling vehicles.

The invention and its advantages will be readily understood in light of the description and exemplary embodiments that follow, and also the sole figure relating to these examples which schematically shows, in radial cross section, an example of a radial tyre in accordance with the invention.

### I—DEFINITIONS

In the present application, the following definitions are understood, in a known manner:
“bead”: the portion of the tyre internally radially adjacent to the sidewall and the base of which is intended to be mounted on a rim seat of a vehicle wheel;
“elastomer layer”: any three-dimensional element made of rubber composition, having any shape or thickness, especially a sheet or strip or other element of any straight, for example rectangular or triangular cross section;
“sidewall”: the portion of the tyre, usually of low flexural stiffness, located between the crown and the bead;
“phr”: signifies parts by weight per hundred parts of elastomer (of the total of the elastomers if several elastomers are present, therefore including the hydrogenated TPS elastomer);
“radial”: a direction that passes through the axis of rotation of the tyre and normal to the latter; this direction may be “radially internal (or inner)” or “radially external (or outer)” depending on whether it is oriented towards the axis of rotation of the tyre or towards the outside of the tyre.

In the present description, unless expressly indicated otherwise, all the percentages (%) indicated are % by weight. Moreover, any interval of values denoted by the expression “between a and b” represents the range of values extending from more than “a” to less than “b” (i.e. limits a and b excluded) whereas any interval of values denoted by the expression “from a to b” means the range of values extending from “a” to “b” (i.e. including the strict limits a and b).

### II—MEASUREMENTS AND TESTS USED

The rubber compositions used in the tyres according to the invention are characterized, before and after curing, as indicated below.

II-1. Mooney Plasticity

Use is made of an oscillating consistometer as described in French Standard NF T 43-005 (1991). The Mooney plasticity measurement is carried out according to the following principle: the composition in the uncured state (i.e., before curing) is moulded in a cylindrical chamber heated to 100° C. After preheating for one minute, the rotor rotates within the test specimen at 2 rpm and the working torque for maintaining this movement is measured after rotating for 4 minutes. The Mooney plasticity (ML 1+4) is expressed in “Mooney unit” (MU, with 1 MU=0.83 Newton.metre).

II.2—Dynamic Properties

The dynamic properties G* (10%) and tan(δ)ₘₐₓ at 40° C. are measured on a viscosity analyser (Metravib VA4000) according to the standard ASTM D 5992-96. The response of a sample of vulcanized composition (cylindrical test specimen with a thickness of 4 mm and with a cross section of 400 mm²), subjected to a simple alternating sinusoidal shear stress, at a frequency of 10 Hz, is recorded. A scan with a strain amplitude ranging from 0.1% to 50% (forward cycle) then from 50% to 1% (return cycle) is carried out. The results gathered are the complex dynamic shear modulus (G*) and the loss factor (tan(δ)). For the return cycle, the maximum value of tan (δ) observed, denoted by tan(δ)ₘₐₓ, and the complex dynamic shear modulus G* (10%) at 10% strain are indicated.

It is recalled, in a manner well known to a person skilled in the art, that the value of tan(δ)ₘₐₓ at 40° C. is representative of the hysteresis of the material, and therefore of the rolling resistance: the lower tan(δ)ₘₐₓ at 40° C., the lower the rolling resistance.

The value of G* (10%) is itself representative of the stiffness: the higher G*, the greater the stiffness.

### III—DETAILED DESCRIPTION OF THE INVENTION

The tyre of the invention comprises a sublayer comprising a rubber composition comprising at least one diene elastomer, a reinforcing filler and more than 10 phr of a hydrogenated thermoplastic styrene copolymer (referred to as “TPS elastomer”) which will be described in detail below.

III.1—Diene Elastomer

The sublayer of the crown of the tyre according to the invention comprises a rubber composition comprising at least un diene elastomer.

It is recalled here that the term “diene” elastomer (or rubber, the two being considered to be synonymous) should be understood to mean, in a known manner, an (one or more is understood) elastomer resulting at least partly (i.e., a homopolymer or a copolymer) from diene monomers (monomers bearing two carbon-carbon double bonds which may or may not be conjugated).

These diene elastomers may be classified into two categories: “essentially unsaturated” or “essentially saturated”. The expression “essentially unsaturated” is generally understood to mean a diene elastomer resulting at least partly from conjugated diene monomers, having a content of units of diene origin (conjugated dienes) that is greater than 15% (mol%). Thus, diene elastomers such as butyl rubbers or diene/a-olefin copolymers of the EPDM type do not fall under the preceding definition and may especially be described as “essentially saturated” diene elastomers (low or very low content of units of diene origin, always less than 15%). In the “essentially unsaturated” diene elastomer category, the expression “highly unsaturated diene elastomer” is understood in particular to mean a diene elastomer having a content of units of diene origin (conjugated dienes) that is greater than 50%.

Having given these definitions, it will be understood more particularly that a diene elastomer capable of being used in the compositions in accordance with the invention means:
(a)—any homopolymer obtained by polymerizing a conjugated diene monomer having from 4 to 12 carbon atoms;
(b)—any copolymer obtained by copolymerizing one or more conjugated dienes with one another or with one or more vinylaromatic compounds having from 8 to 20 carbon atoms;
(c)—a ternary copolymer obtained by copolymerizing ethylene, an a-olefin having from 3 to 6 carbon atoms with an unconjugated diene monomer having from 6 to 12 carbon atoms, such as for example the elastomers obtained from ethylene or propylene and an unconjugated diene monomer of the aforementioned type such as in particular 1,4-hexadiene, ethylidene norbornene and dicyclopentadiene; and
(d)—a copolymer of isobutene and isoprene (butyl rubber), and also the halogenated, in particular chlorinated or brominated, versions of this type of copolymer.

Although the present invention applies to any type of diene elastomer, a person skilled in the art of tyres will understand that it is preferably used with essentially unsaturated diene elastomers, in particular of type (a) or (b) above.

Suitable conjugated dienes are, in particular, 1,3-butadiene, 2-methyl-1,3-butadiene, 2,3-di(C₁-C₅)alkyl-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. Suitable vinylaromatic compounds are, for example, styrene, ortho-, meta- and para-methylstyrene, the commercial “vinyl-toluene” mixture, para-(tert-butyl)styrene, methoxystyrenes, chlorostyrenes, vinylmesitylene, divinylbenzene and vinylnaphthalene.

It is preferred to use at least one diene elastomer of the highly unsaturated type, in particular a diene elastomer selected from the group consisting of polybutadienes (BRs) (especially those having a content of cis-1,4-bonds of greater than 90%), synthetic polyisoprenes (IRs), natural rubber (NR), butadiene copolymers, isoprene copolymers (other than IIR) and mixtures of these elastomers. Such copolymers are more preferably selected from the group consisting of butadiene/styrene copolymers (SBRs), isoprene/butadiene copolymers (BIRs), isoprene/styrene copolymers (SIRs), isoprene/butadiene/styrene copolymers (SBIRs) and mixtures of such copolymers.

The copolymers can comprise between 99% and 20% by weight of diene units and between 1% and 80% by weight of vinylaromatic units. The elastomers can have any microstructure, which depends on the polymerization conditions used, in particular on the presence or absence of a modifying and/or randomizing agent and on the amounts of modifying and/or randomizing agent employed. The elastomers can, for example, be block, random, sequential or microsequential elastomers and can be prepared in dispersion or in solution; they can be coupled and/or star-branched or else functionalized with a coupling and/or star-branching or functionalizing agent. For coupling with carbon black, mention may be made, for example, of functional groups comprising a C—Sn bond or of aminated functional groups, such as aminobenzophenone, for example; for coupling with a reinforcing inorganic filler such as silica, mention may be made, for example, of silanol functional groups or polysiloxane functional groups having a silanol end (as described, for example, in FR 2 740 778, U.S. Pat. No. 6,013,718 or WO 2008/141702), of alkoxysilane groups (as described, for example, in FR 2 765 882 or U.S. Pat. No. 5,977,238), of carboxylic groups (as described, for example, in WO 01/92402, U.S. Pat. No. 6,815,473, WO 2004/096865 or US 2006/0089445) or else of polyether groups (as described, for example, in EP 1 127 909, U.S. Pat. No. 6,503,973, WO 2009/000750, or WO 2009/000752). Mention may also be made, as other examples of such functionalized elastomers, of the elastomers (such as SBR, BR, NR or IR) of the epoxidized type.

According to one particularly preferred embodiment of the invention, the diene elastomer is selected from the group consisting of natural rubber, synthetic polyisoprenes, polybutadienes having a content of cis-1,4-bonds of greater than 90%, butadiene/styrene copolymers and mixtures of these elastomers.

The following are preferably suitable: polybutadienes and in particular those having a content of 1,2-units of between 4% and 80% or those having a content of cis-1,4-units of greater than 80%, polyisoprenes, butadiene/styrene copolymers and in particular those having a styrene content of between 5% and 50% by weight and more particularly between 20% and 40%, a content of 1,2-bonds of the butadiene part of between 4% and 65% and a content of trans-1,4-bonds of between 20% and 80%, butadiene/isoprene copolymers and in particular those having an isoprene content of between 5% and 90% by weight and a glass transition temperature (“T_{g}”, measured according to ASTM D3418-82) from −80° C. to −40° C., or isoprene/styrene copolymers and in particular those having a styrene content of between 5% and 50% by weight and a T_{g} of between −5° C. and −50° C. In the case of butadiene/styrene/isoprene copolymers, those having a styrene content of between 5% and 50% by weight and more particularly of between 10% and 40%, an isoprene content of between 15% and 60% by weight and more particularly between 20% and 50%, a butadiene content of between 5% and 50% by weight and more particularly of between 20% and 40%, a content of 1,2- units of the butadiene part of between 4% and 85%, a content of trans-1,4-units of the butadiene part of between 6% and 80%, a content of 1,2-plus 3,4-units of the isoprene part of between 5% and 70% and a content of trans-1,4-units of the isoprene part of between 10% and 50%, and more generally any butadiene/styrene/isoprene copolymer having a T_{g} of between −5° C. and −70° C., are suitable in particular.

According to one particular and preferred embodiment of the invention, the elastomer sublayer comprises, as diene elastomer, at least 40 phr, more preferably at least 50 phr of natural rubber or synthetic polyisoprene, the latter possibly being combined, or not, with a second diene elastomer, in particular an SBR copolymer (solution or emulsion SBR) or a polybutadiene having a content of cis-1,4-bonds which is preferably greater than 90%.

According to another more particular and preferred embodiment, the sublayer comprises, as diene elastomer, from 40 to 80 phr (more preferably from 50 to 80 phr) of natural rubber or synthetic polyisoprene, with 20 to 60 phr (preferably 20 to 50 phr) of an SBR copolymer or of a polybutadiene having a content of cis-1,4-bonds which is preferably greater than 90%, more preferably still greater than 95%.

According to another particular and preferred embodiment of the invention, the sublayer comprises, as diene elastomer, at least 40 phr, more preferably at least 50 phr, of a polybutadiene (BR) having a content of cis-1,4-bonds which is greater than 90%, more preferably still greater than 95%. More preferably, said polybutadiene is then used as a blend with natural rubber or a synthetic polyisoprene.

According to another particular and preferred embodiment, the diene elastomer used is a ternary blend (mixture) of NR (or IR), BR and SBR. Preferably, in the case of such blends, the composition comprises from 40 to 80 phr of NR (or IR) and from 20 to 60 phr of BR and SBR.

Synthetic elastomers other than diene elastomers, or even polymers other than elastomers, for example thermoplastic polymers, may be combined, in a minority amount, with the diene elastomers described previously.

III.2—Hydrogenated TPS Elastomer

The rubber composition of the sublayer according to the invention has another essential feature of comprising more than 10 phr of a hydrogenated thermoplastic styrene (abbreviated to TPS) copolymer.

It will first be recalled that thermoplastic styrene elastomers (also called “TPS” elastomers) are thermoplastic elastomers which are in the form of styrene-based block copolymers. Having a structure intermediate between thermoplastic polymers and elastomers, they are composed, in a known manner, of hard polystyrene sequences linked by soft elastomer sequences, for example polybutadiene, polyisoprene or poly(ethylene/butylene) sequences. They are often triblock elastomers with two hard segments linked by a soft segment. The hard and soft segments may be in a linear, star or branched configuration. These TPS elastomers may also be diblock elastomers with one single hard segment linked to a soft segment.

Typically, each of these segments or blocks contains at least more than 5, generally more than 10 base units (for example styrene units and isoprene units for a styrene/isoprene/styrene block copolymer).

It will also be recalled that the expression “unsaturated TPS copolymer” should be understood to mean a TPS copolymer that is provided with ethylenically unsaturated groups, that is to say which comprises (conjugated or unconjugated) carbon-carbon double bonds. The expression “saturated TPS copolymer” is understood to mean a TPS copolymer that does not comprise any ethylenically unsaturated groups (i.e. no carbon-carbon double bonds).

As is known and by definition in the present application, a “hydrogenated” TPS elastomer is an elastomer that is partially or completely hydrogenated, that is to say obtained by partial or complete hydrogenation of an unsaturated TPS elastomer.

According to one preferred embodiment, the hydrogenated TPS elastomer results from an unsaturated TPS copolymer that comprises styrene blocks and diene blocks, these diene block being, in particular, isoprene or butadiene blocks.

According to one preferred embodiment, the above TPS copolymer is selected from the group consisting of styrene/butadiene (SB), styrene/isoprene (SI), styrene/butadiene/butylene (SBB), styrene/butadiene/isoprene (SBI), styrene/butadiene/styrene (SBS), styrene/butadiene/butylene/styrene (SBBS), styrene/isoprene/styrene (SIS) and styrene/butadiene/ isoprene/styrene (SBIS) block copolymers and mixtures of these copolymers.

According to one more preferred embodiment, the hydrogenated TPS results from an unsaturated TPS copolymer that comprises styrene/isoprene/styrene (SIS) blocks, and may contain, for example, butadiene blocks.

According to another preferred embodiment of the invention, the styrene content in the TPS elastomer is between 5% and 50%. Below the minimum indicated, the thermoplastic nature of the elastomer runs the risk of being substantially reduced, whereas above the recommended maximum the elasticity of the composition may be adversely affected. For these reasons, the styrene content is more preferably between 10% and 40%, in particular between 15% and 35%.

It is preferred for the glass transition temperature (T_{g}, measured according to ASTM D3418) of the TPS elastomer to be below −0° C., more preferably below −20° C.

The number-average molecular weight (denoted by Mₙ) of the TPS elastomer is preferably between 50 000 and 500 000 g/mol, more preferably between 75 000 and 450 000 g/mol, especially for use of the composition in a tyre sublayer.

The number-average molecular weight (Mₙ) of the TPS elastomer is determined in a known manner by size exclusion chromatography (SEC). The specimen is first dissolved in tetrahydrofuran to a concentration of about 1 g/l; then the solution is filtered on a filter of 0.45 μm porosity before injection. The apparatus used is a WATERS Alliance chromatograph. The elution solvent is tetrahydrofuran, the flow rate is 0.7 ml/min, the temperature of the system is 35° C. and the analysis time is 90 min. A set of four WATERS columns in series having the trade names STYRAGEL (HMW7, HMW6E and two HT6E) is used. The injected volume of the polymer specimen solution is 100 μl. The detector is a WATERS 2410 differential refractometer and its associated software for handling the chromatographic data is the WATERS MILLENNIUM system. The average molecular weights calculated are relative to a calibration curve obtained with polystyrene standards.

The rubber composition preferably comprises at least 15 phr of hydrogenated TPS elastomer, more preferably between 15 and 60 phr, in particular from 15 to 40 phr of such an elastomer. Below the minimum values indicated, the technical effect obtained runs the risk of being insufficient; above the maximum values indicated the hysteresis runs the risk of being adversely affected.

Hydrogenated TPS elastomers resulting from unsaturated TPSs such as those mentioned above are well known and are commercially available, for example sold by the company Kuraray under the name “Hybrar” from the 7000 series.

III.3—Reinforcing Filler

Use may be made of any type of reinforcing filler known for its capabilities of reinforcing a rubber composition which can be used for the manufacture of an inner elastomer layer of tyres, for example an organic filler, such as carbon black, a reinforcing inorganic filler, such as silica, or else a blend of these two types of filler, in particular a blend of carbon black and silica.

All carbon blacks, in particular tyre-grade blacks, are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks, or else, depending on the applications targeted, the blacks of higher series (for example, N660, N683 or N772). The carbon blacks might, for example, be already incorporated in an isoprene elastomer in the form of a masterbatch (see, for example, applications WO 97/36724 or WO 99/16600).

Mention may be made, as examples of organic fillers other than carbon blacks, of functionalized polyvinyl organic fillers as described in applications WO-A-2006/069792, WO-A-2006/069793, WO-A-2008/003434 and WO-A-2008/003435.

The expression “reinforcing inorganic filler” should be understood, in the present application, by definition, to mean any inorganic or mineral filler (whatever its colour and its natural or synthetic origin), also known as “white filler”, “clear filler” or even “non-black filler”, in contrast to carbon black, capable of reinforcing by itself alone, without means other than an intermediate coupling agent, a rubber composition intended for the manufacture of tyres, in other words capable of replacing, in its reinforcing role, a conventional tyre-grade carbon black; such a filler is generally characterized, in a known manner, by the presence of hydroxyl (—OH) groups at its surface.

The physical state in which the reinforcing inorganic filler is provided is not important, whether it is in the form of a powder, of micropearls, of granules, of beads or any other appropriate densified form. Of course, the expression “reinforcing inorganic filler” is also understood to mean mixtures of various reinforcing inorganic fillers, in particular of highly dispersible siliceous and/or aluminous fillers as described below.

Mineral fillers of the siliceous type, in particular silica (SiO₂), or of the aluminous type, in particular alumina (Al₂O₃), are suitable in particular as reinforcing inorganic fillers. The silica used may be any reinforcing silica known to a person skilled in the art, in particular any precipitated or pyrogenic silica having a BET surface area and a CTAB specific surface area that are both less than 450 m²/g, preferably from 30 to 400 m²/g. Mention will be made, as highly dispersible precipitated silicas (HDSs), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface area as described in application WO 03/16837.

The reinforcing inorganic filler used, in particular if it is silica, preferably has a BET surface area of between 45 and 400 m²/g, more preferably of between 60 and 300 m²/g.

Preferably, the content of total reinforcing filler (carbon black and/or reinforcing inorganic filler, such as silica) is between 20 and 200 phr, more preferably between 30 and 150 phr, the optimum being, in a known manner, different depending on the particular applications targeted: the level of reinforcement expected with regard to a bicycle tyre, for example, is, of course, less than that required with regard to a tyre capable of running at high speed in a sustained manner, for example a motorcycle tyre, a tyre for a passenger vehicle or a tyre for a utility vehicle, such as a heavy vehicle.

According to a preferred embodiment of the invention, use is made of a reinforcing filler comprising between 30 and 150 phr, more preferably between 50 and 120 phr of inorganic filler, particularly silica, and optionally carbon black; the carbon black, when it is present, is preferably used at a content of less than 20 phr, more preferably of less than 10 phr (for example between 0.1 and 10 phr).

In order to couple the reinforcing inorganic filler to the diene elastomer, use is made, in a known manner, of an at least bifunctional coupling agent (or bonding agent) intended to provide a satisfactory connection, of chemical and/or physical nature, between the inorganic filler (surface of its particles) and the diene elastomer, in particular bifunctional organosilanes or polyorganosiloxanes.

Use is made in particular of silane polysulphides, referred to as “symmetrical” or “asymmetrical” depending on their specific structure, as described, for example, in applications WO 03/002648 (or US 2005/016651) and WO 03/002649 (or US 2005/016650).

Particularly suitable, without the definition below being limiting, are “symmetrical” silane polysulphides corresponding to the following general formula (I):

Z-A-Sₓ-A-Z, in which: (I)
x is an integer from 2 to 8 (preferably from 2 to 5);
A is a divalent hydrocarbon-based radical (preferably, C₁-C₁₈ alkylene groups or C₆-C₁₂ arylene groups, more particularly C₁-C₁₀, especially C₁-C₄, alkylenes, in particular propylene);
Z corresponds to one of the formulae below:

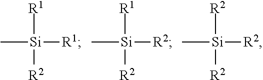

in which:
the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl);
the R² radicals, which are substituted or unsubstituted and identical to or different from one another, represent a C₁-C₁₈ alkoxyl or C₅-C₁₈ cycloalkoxyl group (preferably a group selected from C₁-C₈ alkoxyls and C₅-C₈ cycloalkoxyls, more preferably still a group selected from C₁-C₄ alkoxyls, in particular methoxyl and ethoxyl).

In the case of a mixture of alkoxysilane polysulphides corresponding to the above formula (I), in particular the standard commercially available mixtures, the mean value of the “x” index is a fractional number preferably between 2 and 5, more preferably in the vicinity of 4. However, the invention may also advantageously be carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl)polysulphides (in particular disulphides, trisulphides or tetrasulphides), such as, for example, bis(3-trimethoxysilylpropyl) or bis(3-triethoxysilylpropyl)polysulphides. Use is in particular made, among these compounds, of bis(3-triethoxysilylpropyl)tetrasulphide, abbreviated to TESPT, of formula [(C₂H_{S}O)₃Si(CH₂)₃S₂]₂, or bis(triethoxysilylpropyl)disulphide, abbreviated to TESPD, of formula [(C₂H_{S}O)₃Si(CH₂)₃S]₂. Mention will also be made, as preferred examples, of bis(mono(C₁-C₄)alkoxyldi(C₁-C₄)alkylsilylpropyl) polysulphides (in particular disulphides, trisulphides or tetrasulphides), more particularly bis(monoethoxydimethylsilylpropyl)tetrasulphide, as described in patent application WO 02/083782 (or US 2004/132880).

Mention will in particular be made, as a coupling agent other than an alkoxysilane polysulphide, of bifunctional POSs (polyorganosiloxanes) or else of hydroxysilane polysulphides (R²′OH in the above formula VIII), such as described in patent applications WO 02/30939 (or U.S. Pat. No. 6,774,255) and WO 02/31041 (or US 2004/051210), or else of silanes or POSs bearing azodicarbonyl functional groups, such as described, for example, in patent applications WO 2006/125532, WO 2006/125533 and WO 2006/125534.

In the rubber compositions in accordance with the invention, the content of coupling agent is preferably between 4 and 12 phr, more preferably between 4 and 8 phr.

A person skilled in the art will understand that a reinforcing filler of another nature, in particular organic nature, could be used as filler equivalent to the reinforcing inorganic filler described in the present section, provided that this reinforcing filler is covered with an inorganic layer, such as silica, or else comprises, at its surface, functional sites, in particular hydroxyl sites, requiring the use of a coupling agent in order to form the bond between the filler and the elastomer.

III.4—Various Additives

The rubber compositions of the sublayers described previously also comprise all or some of the usual additives customarily used in elastomer compositions for tyres, such as, for example, pigments, protective agents, such as antiozone waxes, chemical antiozonants, antioxidants, plasticizing agents other than those mentioned above, antifatigue agents, reinforcing resins, methylene acceptors (for example, phenol-novolac resin) or methylene donors (for example, HMT or H3M), a crosslinking system based either on sulphur or on donors of sulphur and/or peroxide and/or bismaleimides, vulcanization accelerators and vulcanization activators.

These compositions may also contain, in addition to coupling agents, coupling activators, agents for covering the inorganic fillers or more generally processing aids capable, in a known manner, owing to an improvement of the dispersion of the filler in the rubber matrix and to a lowering of the viscosity of the compositions, of improving their ability to be processed in the uncured state, these agents being, for example, hydrolysable silanes, such as alkylalkoxysilanes, polyols, polyethers, primary, secondary or tertiary amines or hydroxylated or hydrolysable polyorganosiloxanes.

According to one preferred embodiment, the composition according to the invention also comprises a plasticizing agent. This plasticizing agent may be a solid hydrocarbon-based resin, a liquid plasticizer or a mixture of the two.

The content of plasticizing agent is typically between 0 and 50 phr, more preferrably between 10 and 40 phr.

According to a first preferred embodiment of the invention, this plasticizing agent is a hydrocarbon-based resin, the T_{g} of which is above 0° C., preferably above +20° C.

In a manner known to a person skilled in the art, the term “resin” is reserved in the present patent application, by definition, for a thermoplastic compound which is solid at ambient temperature (23° C.), as opposed to a liquid plasticizing compound such as an oil.

Preferably, the thermoplastic hydrocarbon-based plasticizing resin exhibits at least any one of the following characteristics:
a T_{g} of above 20° C., more preferably of above 30° C.;
a number-average molecular weight (Mₙ) of between 400 and 2000 g/mol, more preferably of between 500 and 1500 g/mol;
a polydispersity index (Iₚ) of less than 3, more preferably of less than 2 (N.B.: Iₚ=M_{w}/Mₙ with M_{w} being the weight-average molecular weight).

More preferably, this hydrocarbon-based plasticizing resin exhibits all of the preferred characteristics above.

The macrostructure (M_{w}, Mₙ and Iₚ) of the hydrocarbon-based resin is determined by size exclusion chromatography (SEC): tetrahydrofuran solvent; 35° C. temperature; 1 g/l concentration; 1 ml/min flow rate; solution filtered through a filter with a porosity of 0.45 μm before injection; Moore calibration with polystyrene standards; set of 3 WATERS columns in series (STYRAGEL HR4E, HR1 and HR0.5); detection by differential refractometer (WATERS 2410) and its associated operating software (WATERS EMPOWER).

The hydrocarbon-based resins may be aliphatic or aromatic or else of aliphatic/aromatic type, i.e. based on aliphatic and/or aromatic monomers. They may be natural or synthetic and may or may not be based on petroleum (if such is the case, they are also known as petroleum resins).

Suitable aromatic monomers are, for example, styrene, a-methylstyrene, ortho-, meta- and para-methylstyrene, vinyl-toluene, para-(tert-butyl)styrene, methoxystyrenes, chlorostyrenes, vinylmesitylene, divinylbenzene, vinylnaphthalene, any vinylaromatic monomer derived from a C₉-cut (or more generally a C₈- to C₁₀-cut). Preferably, the vinylaromatic monomer is styrene or a vinylaromatic monomer derived from a C₉-cut (or more generally a C₈- to C₁₀-cut). Preferably, the vinylaromatic monomer is the minority monomer, expressed as a mole fraction, in the copolymer in question.

According to one particularly preferred embodiment, the hydrocarbon-based plasticizing resin is selected from the group consisting of cyclopentadiene (abbreviated to CPD) or dicyclopentadiene (abbreviated to DCPD) homopolymer or copolymer resins, terpene homopolymer or copolymer resins, terpene-phenol homopolymer or copolymer resins, C₅-cut homopolymer or copolymer resins, C₉-cut homopolymer or copolymer resins, α-methylstyrene homopolymer or copolymer resins and mixtures of these resins, which can be used alone or in combination with a liquid plasticizer, for example an MES or TDAE oil.

The term “terpene” includes here, as is known, α-pinene, β-pinene and limonene monomers. It is preferable to use a limonene monomer, a compound which, as is known, is in the form of three possible isomers: L-limonene (laevogyratory enantiomer), D-limonene (dextrogyratory enantiomer), or else dipentene, the racemic mixture of the dextrogyratory and laevogyratory enantiomers. Mention may especially be made, among the above hydrocarbon-based plasticizing resins, of α-pinene, β-pinene, dipentene or polylimonene homopolymer or copolymer resins.

The above preferred resins are well known to a person skilled in the art and are commercially available, for example:
as regards polylimonene resins: sold by DRT under the name Dercolyte L120 (Mₙ=625 g/mol; M_{w}=1010 g/mol; Iₚ=1.6; T_{g}=72° C.) or by Arizona under the name Sylvagum TR7125C (Mₙ=630 g/mol; M_{w}=950 g/mol; Iₚ=1.5; T_{g}=70° C.);
as regards C₅-cut/vinylaromatic copolymer resins, especially C₅-cut/styrene or C₅-cut/C₉-cut copolymer resins: sold by Neville Chemical Company under the names Super Nevtac 78, Super Nevtac 85 or Super Nevtac 99, sold by Goodyear Chemicals under the name Wingtack Extra, sold by Kolon under the names Hikorez T1095 and Hikorez T1100 or sold by Exxon under the names Escorez 2101 and ECR 373;
as regards limonene/styrene copolymer resins: sold by DRT under the name Dercolyte TS 105 or by Arizona Chemical Company under the names ZT115LT and ZT5100.

Mention may also be made, as examples of other preferred resins, of phenol-modified α-methylstyrene resins. In order to characterize these phenol-modified resins, it is recalled that use is made, in a known manner, of a value known as the “hydroxyl value” (measured according to standard ISO 4326 and expressed as mg KOH/g). The α-methylstyrene resins, in particular the phenol-modified α-methylstyrene resins, are well known to a person skilled in the art and are commercially available, for example sold by Arizona Chemical under the names Sylvares SA 100 (Mₙ=660 g/mol; Iₚ=1.5; T_{g}=53° C.); Sylvares SA 120 (Mₙ=1030 g/mol; Iₚ=1.9; T_{g}=64° C.); Sylvares 540 (Mₙ=620 g/mol; Iₚ=1.3; T_{g}=36° C.; hydroxyl value=56 mg KOH/g); Sylvares 600 (Mₙ=850 g/mol; Iₚ=1.4; T_{g}=50° C.; hydroxyl value=31 mg KOH/g).

According to another preferred embodiment of the invention, the plasticizer is a plasticizer that is liquid at 20° C., referred to as a “low T_{g} plasticizer”, i.e. which has, by definition, a T_{g} of below −20° C., preferably of below −40° C.

Any extender oil, whether of aromatic or non-aromatic nature, any liquid plasticizing agent known for its plasticizing properties with regard to diene elastomers, can be used. Liquid plasticizers selected from the group consisting of naphthenic oils, particularly hydrogenated naphthenic oils, paraffinic oils, MES oils, TDAE oils, ester and ether plasticizers, phosphate and sulphonate plasticizers and the mixtures of these compounds are particularly suitable. Among the ester plasticizers, use can especially be made of the compounds selected from the group consisting of phosphates, trimellitates, pyromellitates, phthalates, 1,2-cyclohexane dicarboxylates, adipates, azelates, sebacates, glycerol triesters, and mixtures of these compounds.

III.5—Preparation of the Rubber Compositions

The compositions used in the sublayers may be manufactured in appropriate mixers using two successive preparation phases well known to a person skilled in the art: a first phase of thermomechanical working or kneading (referred to as a “non-productive” phase) at high temperature, up to a maximum temperature of between 110° C. and 190° C., preferably between 130° C. and 180° C., followed by a second phase of mechanical working (referred to as a “productive” phase) up to a lower temperature, typically below 110° C., for example between 40° C. and 100° C., finishing phase during which the crosslinking system is incorporated.

The process for preparing such compositions comprises, for example, the following stages:
in a mixer, incorporating into at least one diene elastomer, during a first stage (referred to as a “non-productive” stage), more than 10 phr of a hydrogenated TPS copolymer and a reinforcing filler, everything being kneaded thermomechanically (for example in one or more steps), until a maximum temperature of between 110° C. and 190° C. is reached;
cooling the combined mixture to a temperature below 100° C.;
subsequently incorporating, during a second stage (referred to as a “productive” stage), a crosslinking system;
kneading everything up to a maximum temperature below 110° C.

By way of example, the non-productive phase is carried out in a single thermomechanical stage during which, in a first step, all the necessary base constituents (the diene elastomer, more than 10 phr of hydrogenated TPS copolymer, the reinforcing filler) are introduced into an appropriate mixer, such as a standard internal mixer, followed, in a second step, for example after kneading for one to two minutes, by the other additives, optional additional filler-covering agents or processing aids, with the exception of the crosslinking system. The total kneading time, in this non-productive phase, is preferably between 1 and 15 min.

After cooling the mixture thus obtained, the crosslinking system is then incorporated in an external mixer, such as an open mill, maintained at a low temperature (for example, between 40° C. and 100° C.). The combined mixture is then mixed (productive phase) for a few minutes, for example between 2 and 15 min.

The crosslinking system itself is preferably based on sulphur and on a primary vulcanization accelerator, in particular an accelerator of the sulphenamide type. Added to this vulcanization system, are various known secondary accelerators or vulcanization activators, such as zinc oxide, stearic acid, guanidine derivatives (in particular diphenylguanidine), etc., incorporated during the first non-productive phase and/or during the productive phase. The sulphur content is preferably between 0.5 and 3.0 phr and the primary accelerator content is preferably between 0.5 and 5.0 phr.

Use may be made, as (primary or secondary) accelerator, of any compound capable of acting as accelerator of the vulcanization of diene elastomers in the presence of sulphur, in particular accelerators of the thiazole type and also their derivatives, accelerators of the thiuram and zinc dithiocarbamate types. These accelerators are more preferably selected from the group consisting of 2-mercaptobenzothiazyl disulphide (abbreviated to “MBTS”), N-cyclohexyl-2-benzothiazyl sulphenamide (abbreviated to “CBS”), N,N-dicyclohexyl-2-benzothiazyl sulphenamide (abbreviated to “DCBS”), N-tert-butyl-2-benzothiazyl sulphenamide (abbreviated to “TBBS”), N-tert-butyl-2-benzothiazyl sulphenimide (abbreviated to “TBSI”), zinc dibenzyldithiocarbamate (abbreviated to “ZBEC”) and mixtures of these compounds. Preferably, a primary accelerator of the sulphenamide type is used.

The final composition thus obtained may then be calendered, for example in the form of a sheet or a slab, in particular for laboratory characterization, or else is extruded, for example to form a rubber profiled element used for manufacturing a sublayer.

The invention relates to the tyres described above, both in the uncured state (i.e., before curing) and in the cured state (i.e., after crosslinking or vulcanization).

III.6—Tyre of the Invention

The rubber composition described previously is therefore used, in the tyre of the invention, as a sublayer placed circumferentially on the inside of the crown of the tyre, between, on the one hand, the radially outermost part of its tread, i.e., the portion intended to come into contact with the road when rolling, and, on the other hand, the belt that reinforces said crown.

It should therefore be understood that this sublayer is placed:
either under the tread (i.e. radially internally relative to this tread), between the tread and the belt;
or in the tread itself, but in this case under the portion (i.e. radially internally relative to this portion) of tread which is intended to come into contact with the road when the tyre is rolling, throughout the service life of the latter in the new state, it being understood that this sublayer may possibly itself also come into contact with the road after wear on the outer part of the tread; in such a case it should be understood that the tread patterns then penetrate into the sublayer.

The sole appended figure very schematically (in particular not to a specific scale) represents, in radial cross section, a preferred example of a motor vehicle pneumatic tyre having radial carcass reinforcement, in accordance with the invention.

In this figure, the pneumatic tyre (1) shown schematically comprises a crown 2 surmounted by a tread 3 (for simplicity, comprising a very simple tread pattern), the radially outer part (3a) of which is intended to come into contact with the road, two inextensible beads (4) in which a carcass reinforcement (6) is anchored. The crown 2, joined to said beads (4) by two sidewalls (5), is, in a manner known per se, reinforced by a crown reinforcement or “belt” (7) which is at least partly metallic and is radially external with respect to the carcass reinforcement (6), and consists for example of at least two superposed crossed plies reinforced by metal cords.

The carcass reinforcement (6) is here anchored into each bead (4) by winding around two bead wires (4a, 4b), the turn-up (6a, 6b) of this reinforcement (6) being for example positioned towards the outside of the tyre (1), which is shown here mounted on its rim (9). Of course, this tyre (1) additionally comprises, in a known manner, an inner elastomer or rubber layer (commonly referred to as an “inner liner”) that defines the radially inner face of the tyre and that is intended to protect the carcass ply from the diffusion of air coming from the space inside the tyre.

The tyre according to the invention has the feature of comprising a radially inner elastomer layer (3b) known as a “sublayer”, having a formulation different from the formulation of the radially outer elastomer layer (3a) of the tread, this sublayer being placed between the radially outer layer (3a) and the belt (7).

### IV—EXEMPLARY EMBODIMENTS OF THE INVENTION

IV.1—Preparation of the Compositions

The tests which follow are carried out in the following manner: the diene elastomer, the hydrogenated TPS elastomer, the reinforcing filler (silica or carbon black), and also the various other ingredients, with the exception of the vulcanization system, are successively introduced into an internal mixer (final fill factor: around 70% by volume), the initial vessel temperature of which is around 60° C. Thermomechanical working (non-productive phase) is then carried out in one stage, which lasts in total approximately 3 to 4 min, until a maximum “dropping” temperature of 165° C. is reached.

The mixture thus obtained is recovered and cooled and then sulphur and an accelerator of sulphenamide type are incorporated in a mixer (homofinisher) at 30° C., the combined mixture being mixed (productive phase) for an appropriate time (for example, between 5 and 12 min).

The compositions thus obtained are subsequently calendered, either in the form of slabs (thickness of 2 to 3 mm) or of fine sheets of rubber, for the measurement of their physical or mechanical properties, or extruded in the form of a tyre sublayer.

IV.2—Tests

These tests demonstrate, compared to a control composition, the improvement in the stiffness of a rubber composition for a sublayer of a tyre according to the invention, combined with a reduction in hysteresis, and therefore in rolling resistance.

In order to do this, two rubber compositions for a sublayer (3b) of a tyre were prepared as indicated previously, one in accordance with the invention (denoted hereinbelow by C.2) and one not in accordance with the invention (control, denoted hereinbelow by C.1).

Their formulations (in phr or parts by weight per hundred parts of total elastomer, therefore including the hydrogenated TPS elastomer) and their mechanical properties have been summarized in the appended Tables 1 and 2.

Composition C.1 is a reference composition for a person skilled in the art, based on SBR, BR, and NR, conventionally used for manufacturing sublayers.

The formulation of composition C.2 is identical to that of composition C.1 except that the SBR was replaced by a hydrogenated TPS copolymer. Compositions C.1 and C.2 comprise, as plasticizing agent, a mixture of a hydrocarbon-based resin (polylimonene resin) and a liquid plasticizer (MES oil).

On reading Table 2 it is firstly observed that composition C.2 has a Mooney plasticity value similar to that of the control composition C.1 which attests to an equivalent processability of the compositions in the uncured state.

It is then noted that composition C.2 has a value of G* (10%) that is greater than that of the control composition C.1, which is synonymous, for a person skilled in the art, with a stiffening of the crown favourable to an improvement in the handling performance.

Finally, composition C.2 according to the invention has a value of tan(δ)ₘₐₓ at 40° C. which is lower than that of the control composition C.1, which is synonymous with a reduction in the hysteresis of the material and therefore in the rolling resistance.

In conclusion, the results of these tests demonstrate that the use of hydrogenated TPS at the recommended content makes it possible to substantially improve the rolling resistance and handling performance compromise of the tyres according to the invention.

TABLE 1

Composition
No.

| | C.1 | C.2 |
|---|---|---|
| BR (1) | 45 | 45 |
| NR (2) | 35 | 35 |
| SBR (3) | 20 | — |
| TPS elastomer (4) | — | 20 |
| Filler (5) | 85 | 85 |
| Coupling agent (6) | 6.6 | 6.6 |
| Carbon black (7) | 4 | 4 |
| Plasticizer (8) | 36 | 36 |
| Anti-ozone wax | 1.5 | 1.5 |
| Antioxidant (9) | 2 | 2 |
| DPG (10) | 1.5 | 1.5 |
| ZnO (11) | 2 | 2 |
| Stearic acid (12) | 2 | 2 |
| Sulphur | 1.5 | 1.5 |
| CBS (13) | 1.4 | 1.4 |

(1) BR with 0.5% of 1,2-units; 1.2% of trans-units; 98.3% of cis-1,4-units (T_{g} = −106° C.);
(2) NR peptized natural rubber;
(3) SBR solution (content expressed as dry SBR) with 40% of styrene, in the butadiene part 24% of 1,2-units and 48% of trans-1,4-units (T_{g} = −28° C.);
(4) Hydrogenated unsaturated TPS of SIS/SI, “Hybrar 7311” from Kuraray;
(5) Silica: (“Zeosil 1165 MP” from Rhodia);
(6) TESTP coupling agent (“Si69” from Degussa);
(7) Carbon black, N234;
(8) Mixture of MES oil (“Catenex SNR” from Shell) and of polylimonene resin (“Dercolyte L120” from DRT);
(9) N-1,3-dimethylbutyl-N-phenyl-para-phenylenediamine (Santoflex 6-PPD from Flexsys);
(10) DPG = Diphenylguanidine (“Perkacit DPG” from Flexsys);
(11) Zinc oxide (industrial grade - from Umicore);
(12) Stearine (“Pristerene” from Uniquema);
(13) N-cyclohexyl-2-benzothiazyl sulphenamide (Santocure CBS from Flexsys).

TABLE 2

Composition
No.

| | C.1 | C.2 |
|---|---|---|
| Mooney plasticity | 77 | 78 |
| G* (10%) at 40° C. | 8.4 | 9.2 |
| Tan(δ)ₘₐₓ at 40° C. | 0.370 | 0.330 |

1. Radial tire for a motor vehicle, comprising:
a crown surmounted by a tread provided with at least one radially outer elastomer layer intended to come into contact with the road when the tire is rolling;
two inextensible beads, two sidewalls connecting the beads to the tread, a carcass reinforcement passing into the two sidewalls and anchored in the beads;
the crown being reinforced by a crown reinforcement or belt placed circumferentially between the carcass reinforcement and the tread ;
a radially inner elastomer layer known as a “sublayer”, having a formulation different from the formulation of the radially outer elastomer layer, this sublayer being placed between the radially outer layer and the belt,
wherein said sublayer comprises a rubber composition comprising at least one diene elastomer, a reinforcing filler and more than 10 phr of a hydrogenated thermoplastic styrene copolymer (referred to as “TPS elastomer”).

2. Tire according to claim 1, in which the diene elastomer is selected from the group consisting of polybutadienes (BRs), synthetic polyisoprenes (IRs), natural rubber (NR), butadiene copolymers, isoprene copolymers and mixtures of these elastomers.

3. Tire according to claim 1, wherein the content of hydrogenated TPS elastomer is at least 15 phr.

4. Tire according to claim 3, wherein the content of hydrogenated TPS elastomer is between 15 and 60 phr.

5. Tire according to claim 1, wherein the hydrogenated TPS elastomer results from an unsaturated TPS copolymer comprising styrene blocks and diene blocks.

6. Tire according to claim 5, wherein the diene blocks are isoprene or butadiene blocks.

7. Tire according to claim 6, wherein the TPS copolymer is selected from the group consisting of styrene/butadiene, styrene/butadiene/butylene, styrene/isoprene, styrene/butadiene/isoprene, styrene/butadiene/styrene, styrene/butadiene/butylene/styrene, styrene/isoprene/styrene and styrene/ butadiene/isoprene/styrene block copolymers and mixtures of these copolymers.

8. Tire according to claim 1, wherein the rubber composition further comprises a plasticizer.

9. Tire according to claim 8, wherein the content of plasticizer is between 0 and 50 phr.

10. Tire according to claim 1, in which reinforcing filler comprises carbon black, silica, or a mixture of carbon black and silica.

11. Tire according to claim 9, wherein the content of plasticizer is between 10 and 40 phr.
